(19) United States
(12) Patent Application Publication
(10) Pub. No.: US 2014/0033110 A1
(43) Pub. Date: Jan. 30, 2014

(54) Accessing Secondary Functions on Soft Keyboards Using Gestures

(71) Applicant: Texas Instruments Incorporated, Dallas, TX (US)

(72) Inventor: Michael Howard Darden, Dallas, TX (US)

(21) Appl. No.: 13/950,360

(22) Filed: Jul. 25, 2013

Related U.S. Application Data
(60) Provisional application No. 61/675,933, filed on Jul. 26, 2012.

(51) Int. Cl. G06F 3/0488

(52) U.S. Cl. CPC G06F 3/0488
USPC 715/773

(57) ABSTRACT

A method for operating a user interface on a system using gestures that initiate or terminate on a soft-key or is disclosed. One or more keys or buttons may be displayed on a user display. A user provided tap on a key causes a function indicated by the key to be performed. A user provided gesture that originates or terminates on the same key may be detected. An additional key function may then be presented on the user display in accordance with the detected gesture. The additional function may be a palette of key functions, in which case the system responds to a user choice from the palette of functions.

### CLAIM OF PRIORITY UNDER 35 U.S.C. 119(e)

The present application claims priority to and incorporates by reference US Provisional Application number 61/675,933, (attorney docket TI-72656PS) filed Jul. 26, 2012, entitled “Gestures to Access Secondary Functions on Soft Keyboards.”

### FIELD OF THE INVENTION

This invention generally relates to computers and devices that utilize touch screen user interfaces.

### BACKGROUND OF THE INVENTION

A touch screen is an electronic visual display that a user may control through simple or multi-touch gestures by touching the screen with one or more fingers. Some touch screens can also detect objects such as a stylus or ordinary or specially coated gloves. The user can use the touch screen to react to what is displayed and to control how it is displayed, for example, by zooming the text size.

The touch screen enables the user to interact directly with what is displayed, rather than using a mouse, touchpad, or any other intermediate device, other than a stylus, which is optional for most modern touch screens.

Touch screens are common in devices such as game consoles, all-in-one computers, tablet computers, and smart phones. They can also be attached to computers or, as terminals, to networks. They also play a prominent role in the design of digital appliances such as personal digital assistants (PDAs), satellite navigation devices, mobile phones, and video games.

The popularity of smart phones, tablets, and many other types of information appliances is driving the demand and acceptance of common touch screens for portable and functional electronics. Touch screens are popular in the medical field and in heavy industry, as well as in kiosks such as museum displays or room automation, where keyboard and mouse systems do not allow a suitably intuitive, rapid, or accurate interaction by the user with the display's content.

Various technologies have been used for touch screens, including: resistive layers separated by a space, surface acoustic waves, various forms of capacitance coupling, infrared emitters and detectors, optical imaging, acoustic pulse detection, etc.

When using a touch screen, tapping a key causes it to perform its expected function. In many systems, tapping and then holding a key for an extended period of time will reveal additional key functions or choices.

### SUMMARY

A method for operating a user interface on a system using gestures that initiate or terminate on a soft-key is disclosed. One or more keys or buttons may be displayed on a user display. A user provided tap on a key causes a function indicated by the key to be performed. A user provided gesture that originates or terminates on the same key may be detected. An additional key function may then be presented on the user display in accordance with the detected gesture. The additional function may be a palette of key functions, in which case the system responds to a user choice from the palette of functions.

### BRIEF DESCRIPTION OF THE DRAWINGS

Particular embodiments in accordance with the invention will now be described, by way of example only, and with reference to the accompanying drawings:

FIG. 1 is an illustration of a notebook computer that supports gestures to access secondary functions via its virtual keyboard;

FIG. 2 is a block diagram of the notebook computer of FIG. 1;

FIG. 3 illustrates an example soft keyboard in which keys that may accept gestures are illustrated;

FIG. 4 illustrates an example of additional features that may be presented on the soft keyboard in response to a gesture;

FIGS. 5A, 5B, 6A, 6B, 7-8, 9A, 9B, 10A, 10B, 11A and 11B illustrate examples of additional gestures and additional features that may be revealed by a gesture; and

FIG. 12 is a flow diagram illustrating operation of the use of gestures to access secondary functions on a soft keyboard.

Other features of the present embodiments will be apparent from the accompanying drawings and from the detailed description that follows.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

For illustrative purposes, embodiments may be described herein with reference to the TI-Nspire™ handheld graphing calculators and the TI-Nspire™ software available from Texas Instruments. One of ordinary skill in the art will appreciate that embodiments are not limited to the TI-Nspire™ calculator and TI-Nspire™ software.

A handheld calculator such as the TI-Nspire™ is capable of generating and operating on one or more documents. In the TI-Nspire™ environment, a document may include one or multiple problems. Each problem may contain multiple pages. Further, each page may be divided into multiple work areas and each work area may contain any of the TI-Nspire™ applications, e.g., Calculator, Graph, Geometry, Lists & Spreadsheet, Data & Statistics, and Notes. An application may be added to a document, for example, by selecting a corresponding application icon in a menu. The Notes application provides functionality for, among other things, adding and formatting text in a document and the insertion of mathematical expressions. This latter functionality is referred to as a math box or math expression box.

The TI-Nspire™ software executes on a computer system and enables users to perform the same functions on a computer system that can be performed on a TI-Nspire™ calculator, i.e., the software emulates the calculator operation. Documents generated using the TI-Nspire™ software can be used on a TI-Nspire™ calculator and vice versa. Student and teacher versions of the TI-Nspire™ software are described in “TI-nspire™ Student Software Guidebook”, Texas Instruments Incorporated, 2006-2011, and “TI-nspire™ Teacher Software Guidebook”, Texas Instruments Incorporated, 2006-2011. Use of the TI-Nspire software on an iPAD® is described in “Using the TI-Nspire App for iPad for Dummies”, 2013, which is incorporated by reference herein.

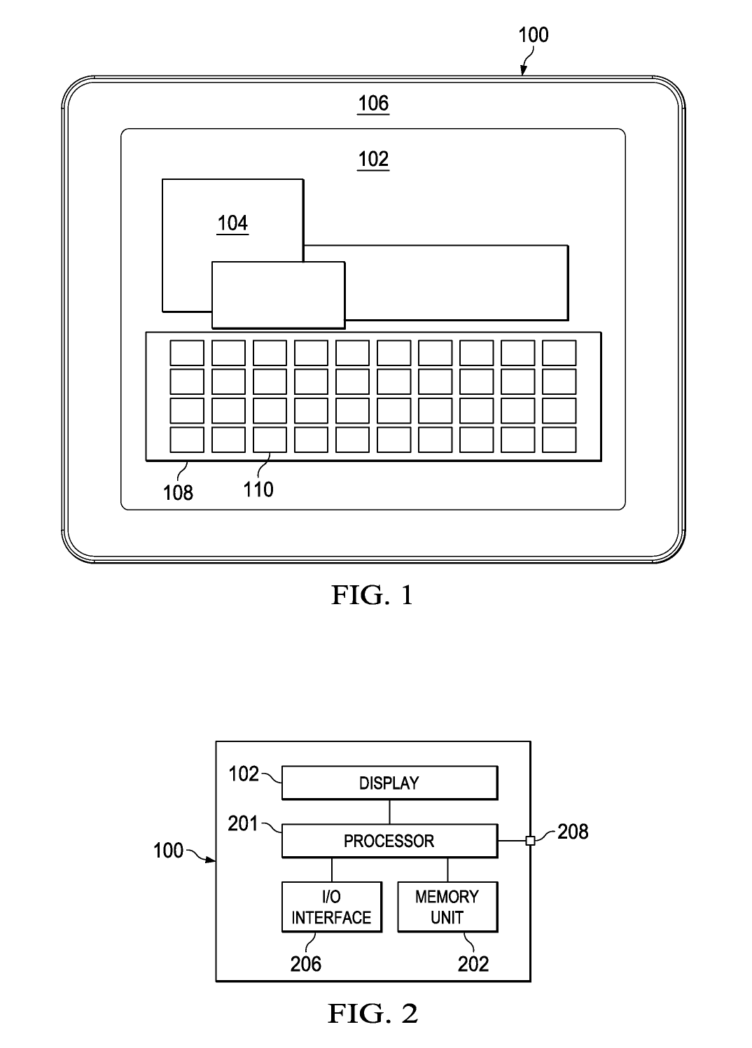

FIG. 1 shows an example notepad computer 100 that includes one or more applications that support gestures to access secondary functions via its virtual keyboard. As opposed to the known technique of a tap and hold on a particular key to enable an alternate key function or palette of functions, gestures allow rapid operation without waiting for the time delay required by tap and hold. As shown in FIG. 1, notepad computer 100 includes a graphical display 102 that may be used to display, among other things, information input to applications executing on the handheld calculator 100 and various outputs of the applications. For example, each application may use one or more windows 104 for displaying input and output information, as is well known in computer technology. The graphical display 102 may be, for example, an LCD display. One or more control buttons (not shown) may be provided in some embodiments, such as a power button, volume control buttons, etc.

Notepad computer 100 does not have a dedicated keyboard; instead, one or more applications may provide a virtual, or a “soft keyboard” as illustrated by application window 108 that includes a set of keys 110. Display 102 includes touch detection circuitry that allows a user to interact with the display 102 by translating the motion and position of the user's fingers on the display 102 to provide functionality similar to using an external pointing device, such as a mouse, and a keyboard. A user may use the touch sensitive display 102 to perform operations similar to using a pointing device on a computer system, e.g., scrolling the display 102 content, pointer positioning, selecting, highlighting, etc. The general operation of a touch sensitive display screen is well known and need not be described in further detail herein. For example, in some embodiments, a detection circuitry may be located in a peripheral region 106 around the touch sensitive screen. In other embodiments, transparent circuitry may be formed on the face of the screen that detects the presence and location of a finger or pointing instrument that is placed near or in contact with the surface of the screen, etc. Embodiments of the invention that may be used with many types of currently known or later development touch sensitive screens.

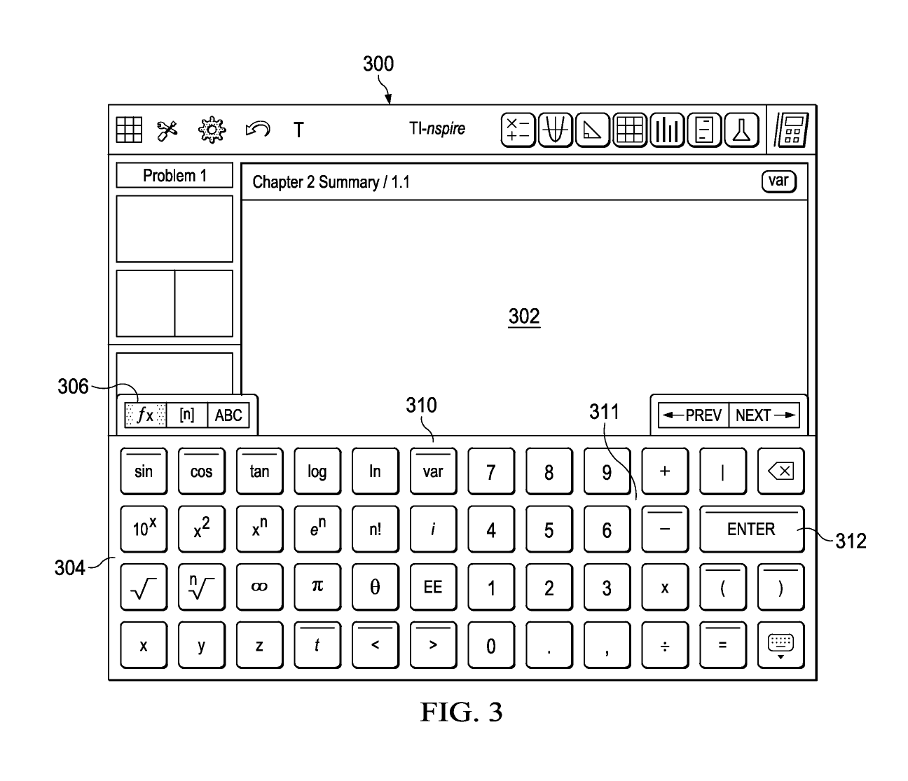

FIG. 2 is a simplified block diagram of notepad computer 100. Notepad computer 100 includes a processor 201 coupled to a memory unit 202, which may include one or both of read-only memory (ROM) and random-access memory (RAM). In some embodiments, the ROM stores software programs implementing functionality described herein and the RAM stores intermediate data and operating results.

Touch sensitive display 102 includes control and interface circuitry and is controllably coupled to processor 201 so that touch location input data may be provided to processor 201. An input/output port 208 may provide connectivity to external devices. Input/output port 208 may be a bi-directional connection such as a mini-A USB port, for example. Also included in the notepad computer 100 may be an I/O interface 206. The I/O interface 206 provides an interface to couple input devices such as power control and volume control buttons, for example, to processor 201. In some embodiments, the notepad computer 100 may also include an integrated wireless interface (not shown) or a port for connecting an external wireless interface (not shown).

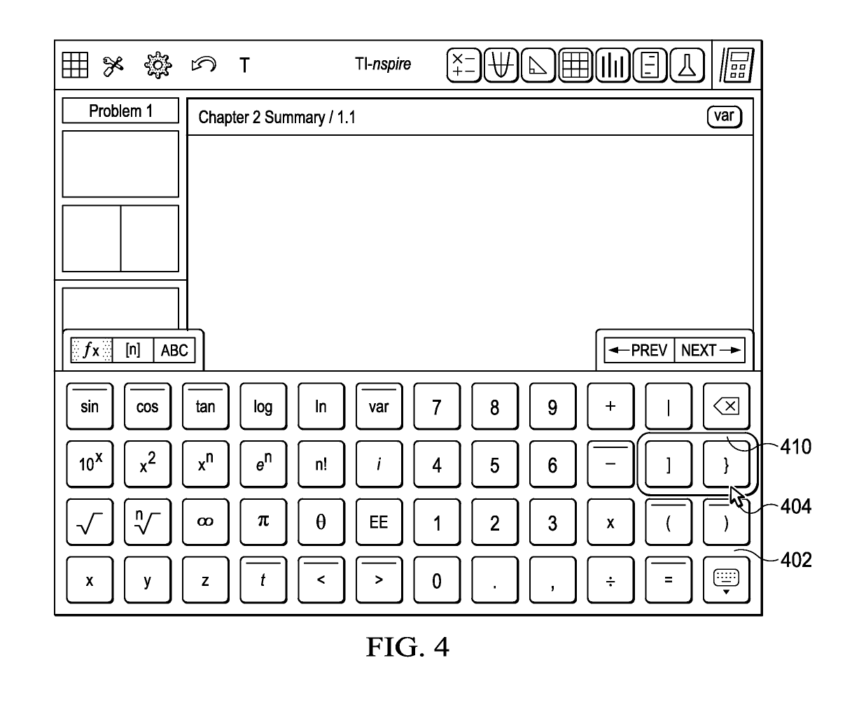

FIG. 3 illustrates an example of an application window that provides a soft keyboard in which keys that may accept gestures are illustrated. In this example, an application window 300 includes a display region 302 for showing input and result data, and a keyboard region that contains a set of virtual keys, as indicated generally at 304. This example is for a calculator application that is included in the TI-Nspire application; however, other embodiments may use various configurations of a soft keyboard. In this example, virtual function tab 306 indicates the calculator application is active. A user may select another tab to switch to another virtual keyboard at any time.

Some keys have secondary functions that are “hidden” from the user, but the presence of these secondary functions may be indicated, for example, by a bar across the top of the key, as indicated generally at 310-312.

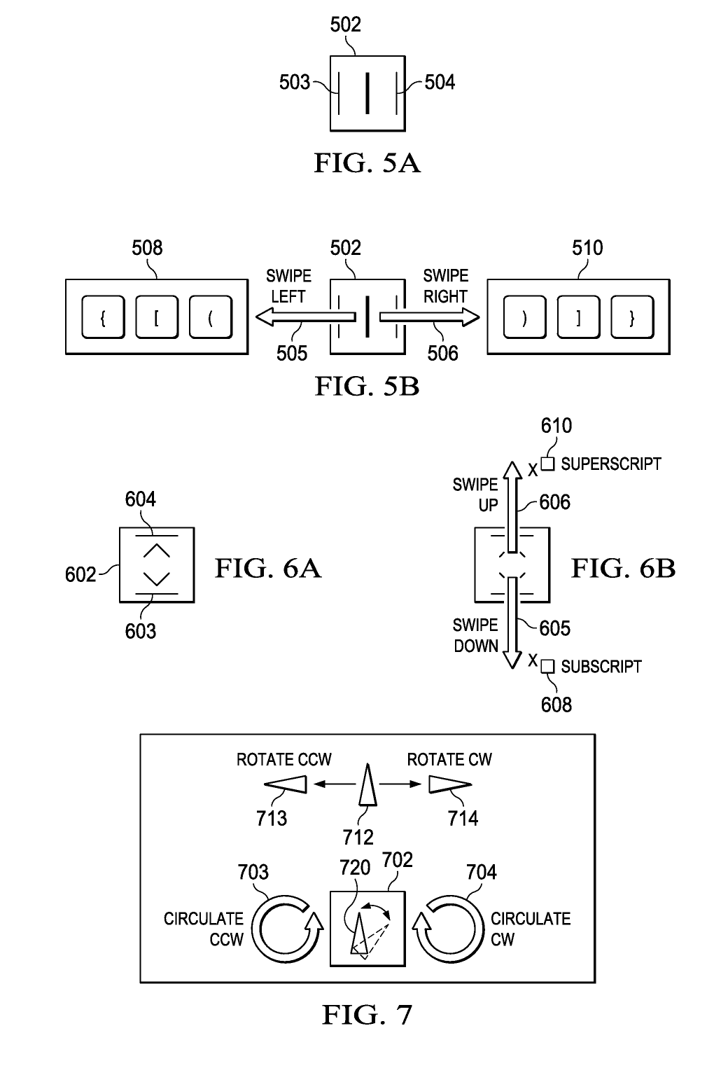

FIG. 4 illustrates an example of additional features that may be presented on the soft keyboard in response to a gesture. In this example, right parentheses “)” key 402 has hidden functions that include a right brace “}” and a right bracket “]”. An upward gesture originating on key 402, i.e., touching key 402 with a finger, or other indicator instrument, and sliding the finger upward as indicated at 404, may be detected by detection logic associated with touch sensitive screen 102. In response to detecting this upward gesture from key 402, a palette of two hidden function keys is displayed, as indicated at 410. A user may now select either of these two previously hidden keys. Of course, a palette of more than two hidden functions may be revealed for a given key, or, only a single hidden function may be revealed, depending on the needs of an application.

In some embodiments, a palette may be “non-sticky”, in which case the user may then select the desired secondary function by sliding his/her finger to the desired secondary key. In some embodiments, the newly revealed functions may be presented as “sticky” secondary palettes, in which case the user may pull his/her finger away from the touch sensitive screen after the secondary options are revealed without dismissing a palette.

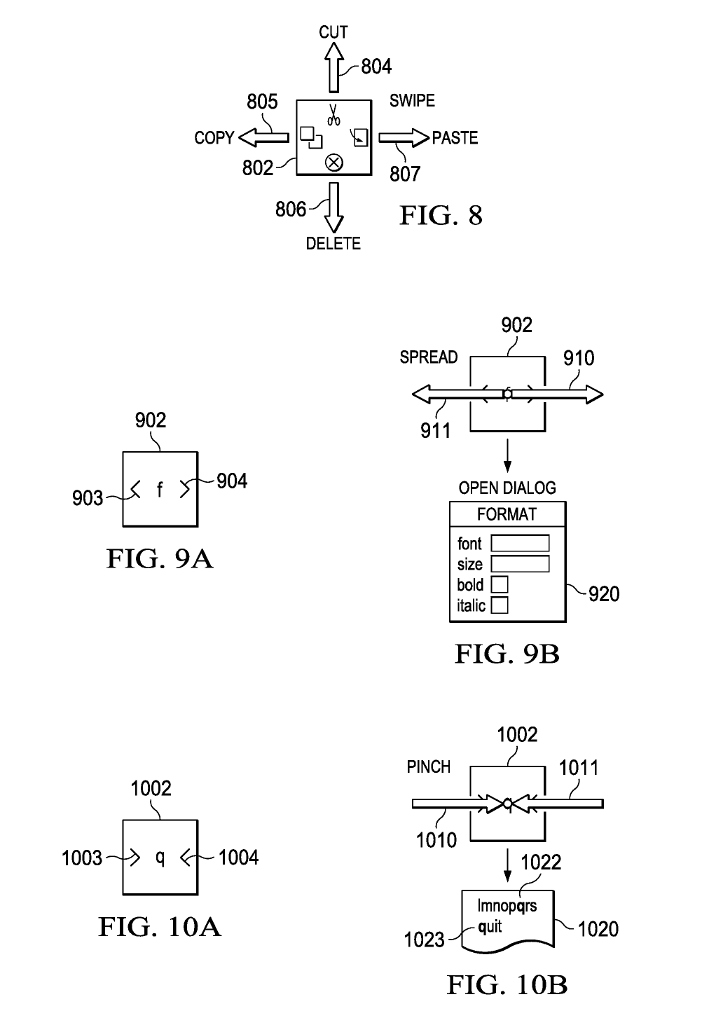

FIGS. 5A-11B illustrate additional examples of gestures and additional features that may be revealed by a gesture. If appropriately chosen, a gesture may increase keyboard versatility because multiple sets of secondary functions may be assigned to a single key and revealed according to the “direction” of the gesture. Such gestures may include but are not limited to, gestures natively recognized by a given operating system (swipe, circulate, arc, pinch) as well as custom gestures. The intent here is not to specify a particular set of gestures, because there may be a large number of possible gestures, but rather to illustrate how any gesture that originates from or terminates on a given keyboard key or displayed object may be used to access secondary functions. It should be understood that as used herein the term “gesture” requires some sort of quick movement of the pointing device or finger initiated from or terminating on the target key, as opposed to a tap and hold that requires an extended dwell time of the pointing device or finger on the target key.

FIG. 5A illustrates a key 502 that includes an extended function bar 503 on its left side and an extended function bar 504 on its right side to indicate that two different extended function palettes are associated with key 502.

FIG. 5B illustrates revelation of a left palette 508 or a right palette 510 with “swipe left” 505 or “swipe right” 506 that originates from key 502. Swiping left reveals the left parenthesis, bracket, and brace. Swiping right from the same key reveals the right partner to these characters.

FIG. 6A illustrates a key 602 that includes an extended function bar 603 on its bottom side and an extended function bar 604 on its top side to indicate that two different extended function palettes are associated with key 602.

FIG. 6B illustrates initiation of formatting actions with “swipe up” 606 or “swipe down” 605 gestures originating from key 602. For example, a superscript 610 is initiated by swipe up 606 and a subscript 608 is initiated by swipe down 605.

FIG. 7 illustrates rotation of objects with “circulate clockwise (CW)” 704 or “circulate counter-clockwise (CCW)” 703 arc gestures originating from or terminating on a key, such as on a single “rotate” key 702. Object 712 is representative of any object that may be displayed on display region 302 of notepad computer 100. After selecting object 712, such as by touching it, circle CW gesture 704 causes object 712 to rotate clockwise, as illustrated at 714. Circle CCW gesture 703 rotates object 712 counter-clockwise, as illustrated at 713.

Notice that rotate key 702 does not include an extended function bar but instead includes an icon 720 that indicates additional functions are available.

FIG. 8 illustrates initiating an edit action with “swipe” up 804, down 806, left 805, or right 807. In this example, edit functions such as cut, copy, paste, and delete may be invoked from a single edit key 802 using directional swipe gestures that originate from edit key 802. Notice that edit key 802 does not include an extended function bar but instead includes a set of icons that indicates additional functions are available.

FIG. 9A illustrates a key 902 that includes an extended function indicator 903 on its left side and an extended function indicator 904 on its right side to indicate that an extended function palette is associated with key 902 and may be accessed by doing a “spread” gesture originating on key 902.

FIG. 9B illustrates opening a dialog box 920 by performing a “spread” gesture 910, 911 originating on a key. In this example a formatting dialog box 920 is opened by a spread gesture 910, 911 originating on the “f” key 902. Formatting dialog box 920 may offer additional functions such as font, size, bold, italicize, etc. While use of the “f” key was illustrated here to indicate a “formatting” dialog box, other keys may be used instead. Similarly, other types of dialog boxes may be opened using spread gestures that originate on other keys of the soft keyboard.

FIG. 10A illustrates a key 1002 that includes an extended function indicator 1003 on its left side and an extended function indicator 1004 on its right side to indicate that an extended function palette is associated with key 1002 and may be accessed by doing a “pinch” gesture terminating on key 1002.

FIG. 10B illustrates highlighting all occurrences of a given item with “pinch” gesture 1010, 1011 terminating on a key. In this example, pinching the “q” key 1002 causes all instances of the letter “q” to be highlighted within an active document displayed on region 302 of display 300. Similarly, other letter keys could be “pinched” to cause all occurrences of other letters to be highlighted.

In this example, while extended function indicators 1003, 1004 were illustrated in FIG. 10A, they may be omitted if it may be understood that every letter key is sensitive to a pinch gesture. In other embodiments, pinching a particular key may be used to initiate a different function or palette of functions, for example. In such embodiments, the presence of extended function indicators 1003, 1004 on a particular key or set of keys may be useful.

FIGS. 11A and 11B illustrate an example of invoking a traditional control function or shortcut with an “arc” gesture originating on a key. In this example, a document 1120 is displayed in display region 302. A particular word or section 1122 needs to be cut, or removed, from the document. After selecting the word or section 1122, a cut function (shortcut control-x on a traditional keyboard) may be invoked by an arc gesture 1110 initiated from the letter “x” key 1102. As illustrated in FIG. 11B, the selected word or object is then cut from document 1120. Similarly, an arc gesture initiated from the letter “c” key or an arc gesture initiated from the letter “v” key may initiate copy or paste functions, for example.

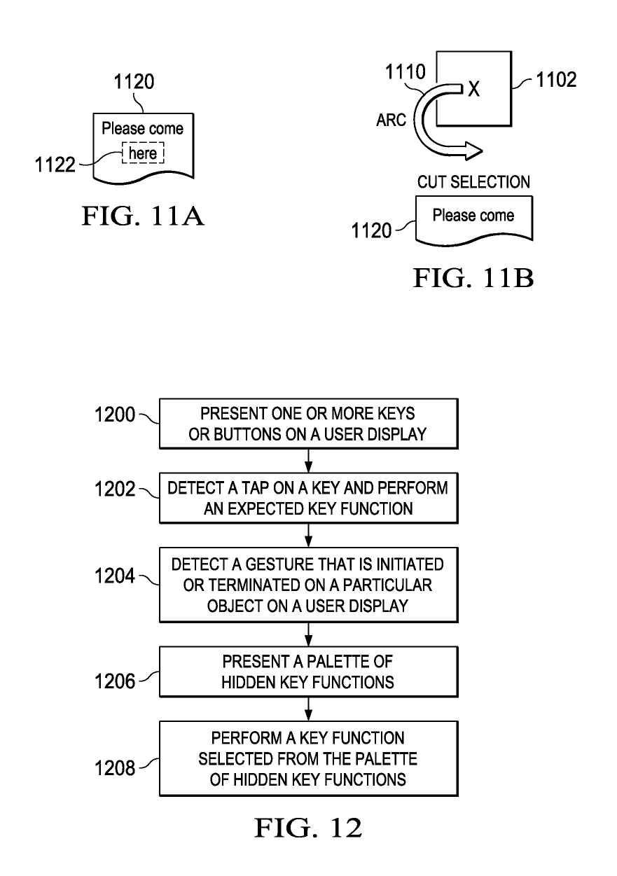

FIG. 12 is a flow diagram illustrating operation of accessing secondary functions on soft keyboards using gestures. One or more keys or buttons may be presented 1200 on a touch sensitive user display screen. The keys or buttons may be arranged into a virtual keyboard, for example. The keys may also be arranged on a tool bar along a perimeter of the display screen, for example, or may be presented in other locations that are pertinent to an application that is being executed by a system that is coupled to the display screen.

A user interacts with the keyboard by tapping 1202 on a key. In response to the tap, an expected key function is performed. For example, when a user taps a key for the letter “x”, an “x” will be placed on the screen. From time to time, a user may interact with the system and draw a gesture on the touch sensitive display screen that is either initiated on one of the keys or is terminated on one of the keys. The gesture may be drawn by a user's finger or a pointing device that is recognized by the touch sensitive screen. The gesture may also be drawn using a mouse or joy stick in some embodiments, for example. When a gesture that is initiated or terminated on one of the keys is detected 1202, then an alternate key function may be performed or a palette of hidden key functions may be presented 1204 on the display screen.

After a user selects one of the hidden key functions from the palette, then the selected function is performed 1206. Alternatively, a function may be performed without waiting for a selection when only one function is presented. For example, referring back to FIG. 8, a formatting function may be performed based on the direction of a swipe gesture. Similarly, referring to FIG. 10B, a document search may be performed immediately based on detection of a gesture terminating on a selected letter key.

In this manner, alternate or hidden key functions may be selected without the need to wait for a tap and hold time period.

### Combinations

By using different gestures, a same key may be used to initiate different functions. Referring back to FIG. 10B, a pinch gesture on key “x” 1102 may cause all instances of the letter “x” to be highlighted within an active document displayed on region 302 of display 300, while an arc gesture initiated on key “x” 1102 may initiate a cut function as described in FIG. 11B.

In a similar manner, gestures that originate from or terminate on non-keyboard user interface (UI) elements may initiate additional function palettes. For example, buttons on a toolbar may be “swiped”, “squeezed” or “pinched”, “expanded” or “spread”, etc to invoke one or more different sets of functional palettes.

Referring again to FIG. 7 and to FIG. 11 B, a same or similar gesture may have different meanings when initiated or terminated on different keys.

### Other Embodiments

While the invention has been described with reference to illustrative embodiments, this description is not intended to be construed in a limiting sense. Various other embodiments of the invention will be apparent to persons skilled in the art upon reference to this description. For example, mouse movements that simulate gestures may also initiate hidden key function palettes when a gesture is initiated or terminated over a particular key or button on a screen.

Once a gesture has been detected and the hidden choices presented, the palette may be either sticky or non-sticky. A system designer may decide how each palette operates. If the gesture reveals an alternate keyboard, the keyboard will likely remain until a key is selected (single choice) or until the user taps away (multiple choices). If the gesture initiates an action (like “copy”), then there may be some feedback to the user that the action has been completed. If a gesture changes a mode (such as “superscript”) then there may be some indicator that the mode has changed. The operation of selected hidden functions may be performed in the same way as if the action or mode was initiated in a prior art manner.

Embodiments of the concepts described herein are not meant to be limited to calculator-style keyboards and may be applied to any soft keyboard. Embodiments may be provided, for example, for tablets, digital reading devices, mobile phones, desktop computers, portable computers, vehicle displays, and special-purpose appliances with touch keyboards.

Embodiments may also be implemented in text editing environments other than that of a handheld notepad computer or calculator emulation. For example, domain specific text formatting as described herein may be used in general purpose text editors.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope and spirit of the invention.

What is claimed is:

1. A method for operating a user interface on a system, the method comprising:
displaying a virtual keyboard having a plurality of keys on a user display;
detecting a tap on a first key of the plurality of keys and performing a function indicated by the first key;
detecting a user provided gesture that originates or terminates on the first key; and
presenting an additional key function on the user display for the first key in accordance with the detected gesture.

2. The method of claim 1, wherein the additional key function is a palette of hidden key function choices, further comprising responding to a user choice from the palette of hidden key functions.

3. The method of claim 1, wherein the user provided gesture is a swipe in one or more different directions that initiates on the first key.

4. The method of claim 1, wherein the user provided gesture is a pinch gesture that terminates on the first key.

5. The method of claim 1, wherein the user provided gesture is a spread gesture that initiates on the first key.

6. The method of claim 1, wherein the user provided gesture is an arc gesture that originates on the first key.

7. The method of claim 1, wherein the virtual keyboard forms a tool bar.

8. The method of claim 7, further comprising including an extended function indicator on one or more keys to visually indicate that the one or more keys will respond to a user provided gesture.

9. A system comprising:
a touch sensitive display screen;
gesture detection logic coupled to the touch sensitive display screen, and
an instruction processor coupled to a memory, wherein the instruction processor is controllably coupled to the gesture detection logic and to the touch sensitive screen, wherein the instruction processor is operable to execute instructions that cause a method for operating a user interface on the touch sensitive display screen to be performed, the method comprising:
displaying a virtual keyboard having a plurality of keys on the display screen;
detecting a tap on a first key of the plurality of keys and performing a function indicated by the first key;
detecting a user provided gesture that originates or terminates on the first key; and
presenting an additional key function on the display screen for the first key in accordance with the detected gesture.

10. The system of claim 9, wherein the additional key function is a palette of key functions, further comprising responding to a user choice from the palette of key functions.

11. The system of claim 9, wherein the user provided gesture is a swipe in one or more different directions that initiate on the first key.

12. The system of claim 9, wherein the user provided gesture is a pinch gesture that terminates on the first key.

13. The system of claim 9, wherein the user provided gesture is a spread gesture that initiates on the first key.

14. The system of claim 9, wherein the user provided gesture is an arc gesture that originates on the first key.

15. The system of claim 9, wherein the virtual keyboard forms a tool bar.

16. The system of claim 15, further comprising including an extended function indicator on one or more keys to visually indicate the key will respond to a user provided gesture.

17. A non-transitory computer-readable medium storing software instructions that, when executed by a processor, cause a method for operating a user interface on a system to be performed, the method comprising:
displaying a virtual keyboard having a plurality of keys on a user display;
detecting a tap on a first key of the plurality of keys and performing a function indicated by the first key;
detecting a user provided gesture that originates or terminates on the first key; and
presenting an additional key function on the user display for the first key in accordance with the detected gesture.

18. The method of claim 17, wherein the additional key function is a palette of key functions, further comprising responding to a user choice from the palette of key functions.

19. The method of claim 17, wherein the user provided gesture is a swipe in one or more different directions that initiate on the first key.

20. The method of claim 17, wherein the virtual keyboard forms a tool bar.
